(19) United States
(12) Patent Application Publication
(10) Pub. No.: US 2025/0239712 A1
(43) Pub. Date: Jul. 24, 2025

(54) BATTERY MODULE ASSEMBLY

(71) Applicant: SAMSUNG SDI CO., LTD., Yongin-si (KR)

(72) Inventor: Yusik Hwang, Yongin-si (KR)

(21) Appl. No.: 19/011,818

(22) Filed: Jan. 7, 2025

(30) Foreign Application Priority Data
Jan. 23, 2024 (KR) 10-2024-0010146

(51) Int. Cl. H01M 50/249; H01M 10/42; H01M 10/613; H01M 10/625; H01M 10/63; H01M 10/647; H01M 10/6563; H01M 50/209; H01M 50/271; H01M 50/284

(52) U.S. Cl. CPC H01M 50/249; H01M 10/425; H01M 10/613; H01M 10/625; H01M 10/63; H01M 10/647; H01M 10/6563; H01M 50/209; H01M 50/271; H01M 50/284; H01M 2010/4271; H01M 2010/4278

(57) ABSTRACT

Provided is a battery module assembly. The battery module assembly includes a plurality of battery modules and a pack space accommodating the plurality of battery modules, in which the pack space includes a recessed space having a bottom surface, a part of which is locally recessed to accommodate at least a part of each of the plurality of battery modules, a module mounting portion in which the plurality of battery modules accommodated in the recessed space are arranged, a circuit mounting portion in which circuit components electrically connected to the plurality of battery modules are arranged, a barrier formed between the module mounting portion and the circuit mounting portion, and a wire guide connecting the module mounting portion to the circuit mounting portion across the barrier. One or more embodiments include a power supply device having reduced weight and volume and having a light, thin, and compact structure by mounting a plurality of battery modules and a circuit component electrically connected thereto directly on an electric vehicle in a pack-less manner without a separate package in which the plurality of battery modules and the circuit component are separated from the electric vehicle.

### CROSS-REFERENCE TO RELATED APPLICATION

The present application claims priority and the benefit of Korean Patent Application No. 10-2024-0010146, filed on Jan. 23, 2024, in the Korean Intellectual Property Office, the entire disclosure of which is incorporated herein by reference in its entirety.

### BACKGROUND

### 1. Field

One or more embodiments relate to a battery module assembly.

### 2. Description of the Related Art

Generally, a secondary battery can be charged and discharged, unlike a primary battery that cannot be recharged. Secondary batteries are used as energy sources for mobile devices, electric vehicles, hybrid vehicles, electric bicycles, uninterruptible power supplies, etc. According to a type of an external device to which they are applied to, secondary batteries are used in the form of a single battery or a pack in which multiple battery cells are connected and grouped into one unit.

Small mobile devices such as mobile phones may operate for a certain amount of time based on the output and capacity of a single battery, whereas for devices requiring long-term driving and high-power operations such as electric vehicles, hybrid vehicles, etc., and consuming a lot of power, a secondary battery of a pack type including a plurality of batteries is preferred due to output and capacity issues. The output voltage or output current may be increased with the number of built-in batteries.

### SUMMARY

One or more embodiments include a power supply device having reduced weight and volume and having a light, thin, and compact structure by mounting a plurality of battery modules and a circuit component electrically connected thereto directly on an electric vehicle in a pack-less manner without a separate package in which the plurality of battery modules and the circuit component are separated from the electric vehicle.

Additional aspects will be set forth in part in the description which follows will be apparent from the description, or may be learned by practice of the presented embodiments of the present disclosure.

According to one or more embodiments, a battery module assembly includes a plurality of battery modules and a pack space accommodating the plurality of battery modules, in which the pack space includes a recessed space having a bottom surface, a part of which is locally recessed to accommodate at least a part of each of the plurality of battery modules, a module mounting portion in which the plurality of battery modules accommodated in the recessed space are arranged, a circuit mounting portion in which circuit components electrically connected to the plurality of battery modules are arranged, a barrier formed between the module mounting portion and the circuit mounting portion, and a wire guide connecting the module mounting portion to the circuit mounting portion.

The battery module assembly may further include a foldable cover opening and closing the pack space, in which the foldable cover covers a top surface of the pack space that is opposite to a bottom surface of the pack space.

Each of the plurality of battery modules may be position-fixed in the recessed space by an engaging means engaged with a fixture installed on the bottom surface of the recessed space via a flange piece formed in each of the plurality of battery modules or an engaging means engaged with a fixture installed on the bottom surface of the recessed space via a pressing piece pressing a plurality of battery modules adjacent to each other together.

The circuit mounting portion may include a battery management system (BMS) configured to control charging and discharging operations of the plurality of battery modules and a power relay assembly (PRA) configured to control a power flow from the plurality of battery modules to a driving motor.

The module mounting portion may further include a cooling fan for cooling the plurality of battery modules.

The cooling fan and the power relay assembly of the circuit mounting portion may be electrically connected to each other by a wire guided along a wire guide extending across the barrier.

The wire guide may be formed in a groove shape recessed from the bottom surface of the pack space along an edge of the pack space to enclose the module mounting portion surrounding the recessed space, the circuit mounting portion, and the barrier between the module mounting portion and the circuit mounting portion, and may be formed in a loop shape having opposite ends disconnected from each other, with mounting positions of the PRA and the cooling fan between ends of the loop shape along an edge of the pack space.

Fixtures for fixing the PRA and the cooling fan may be formed at the opposite ends of the wire guide disconnected from each other, and each of the PRA and the cooling fan may be fixed to the pack space by an engaging member inserted into the fixtures.

A power port providing input and output positions of charging and discharging power of the battery module and a communication port connected to the BMS to enable data communication with the BMS may be formed on an outer side of the wire guide.

The pack space may be formed as a space under a loading space on which a transfer load is loaded.

The pack space and the loading space may be formed integrally with one base frame.

A foldable cover may be arranged on the base frame and be extendable between the pack space and the loading space.

The pack space and the loading space may be divided from or connected to each other by opening and closing of the foldable cover.

The base frame may include a sliding guide extending between the pack space and the loading space to support sliding of the foldable cover and an upper wall and a lower wall branched upwardly and downwardly from the sliding guide and dividing a part of the loading space and a part of the pack space, respectively.

The base frame may be assembled on a vehicle body of the electric vehicle with the plurality of battery modules being configured to provide a driving power source for the electric vehicle.

At least a part of a wall dividing the pack space may be provided by a vehicle body of an electric vehicle.

The bottom surface of the pack space may be provided by the vehicle body of the electric vehicle.

The plurality of battery modules may be provided in a compact arrangement with respect to each other as being at least partially accommodated in the recessed space, and a binding mechanism for physically binding the plurality of battery modules to each other may not be included.

The battery module assembly is provided with an electric vehicle, with the plurality of battery module being configured to provide a driving power source for the electric vehicle, and housing for forming the plurality of battery modules and the circuit components electrically connected to the plurality of battery modules in one package separated from the electric vehicle using the plurality of battery modules as a driving power source may not be included.

### BRIEF DESCRIPTION OF THE DRAWINGS

The above and other aspects, features, and advantages of certain embodiments of the present disclosure will be more apparent from the following description taken in conjunction with the accompanying drawings.

FIG. 1 is a view for describing a structure of a battery module assembly according to embodiments of the present disclosure, the structure including a plurality of battery modules as a driving power source for an electric vehicle and a pack space accommodating the plurality of battery modules;

FIGS. 2A and 2B are top views of a pack space to show components defining a pack space opened and closed by folding and unfolding of a foldable cover;

FIGS. 3A and 3B are side views of a pack space to show components defining a pack space opened and closed by folding and unfolding of a foldable cover;

FIG. 4 is a perspective view of a base frame shown in FIGS. 2 and 3;

FIG. 5 is a view for describing a configuration of a pack space shown in FIG. 1;

FIG. 6 is a view for describing an arrangement structure of a battery module assembly arranged in an electric vehicle;

FIG. 7 schematically shows connection of a power line and a communication line between a battery module assembly and a vehicle controller; and

FIG. 8 shows a power relay assembly for opening and closing a power flow between a plurality of battery modules and a driving motor.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” if preceding a list of elements, modify the entire list of elements and do not modify the individual elements of the list.

Hereinafter, a battery module assembly according to embodiments of the present disclosure will be described with reference to the drawings attached to the specification.

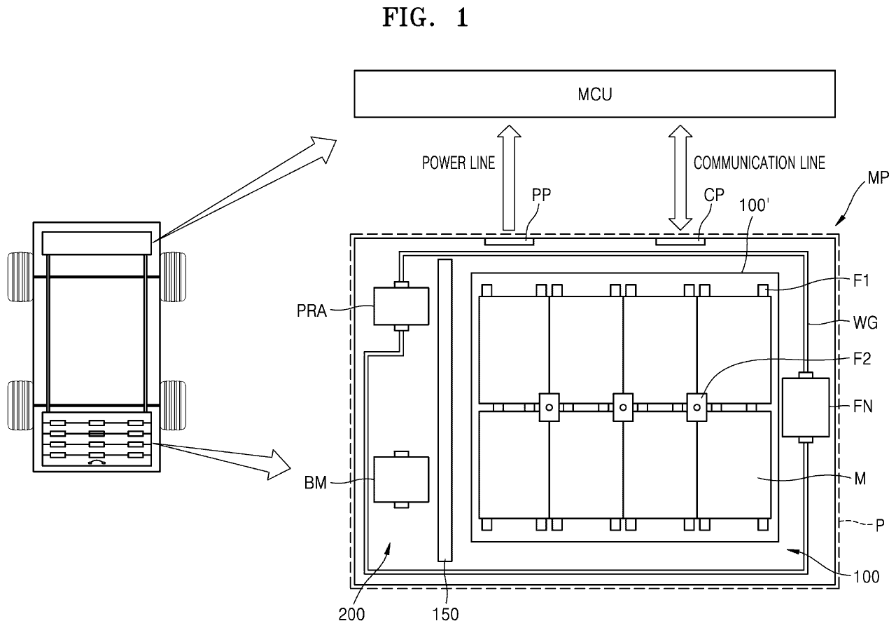

FIG. 1 is a view for describing a structure of a battery module assembly MP according to embodiments of the present disclosure, the structure including a plurality of battery modules M as a driving power source for an electric vehicle and a pack space P accommodating the plurality of battery modules M.

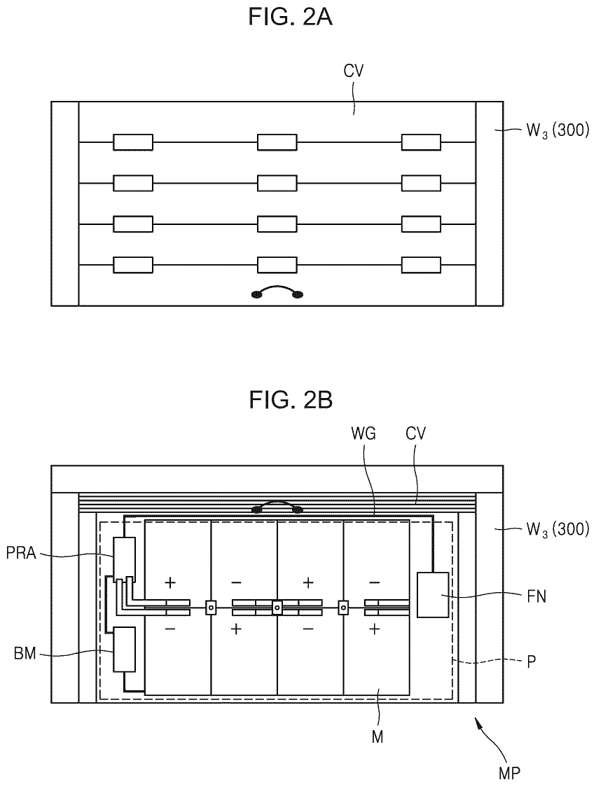

FIGS. 2A and 2B are top views of the pack space P to show components defining the pack space P opened and closed by folding and unfolding of a foldable cover CV.

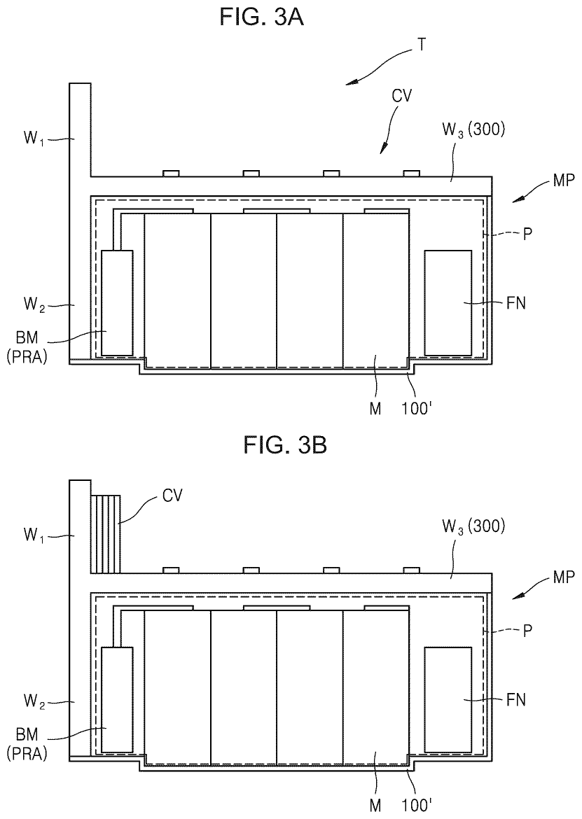

FIGS. 3A and 3B are side views of the pack space P to show components defining the pack space P opened and closed by folding and unfolding of the foldable cover CV.

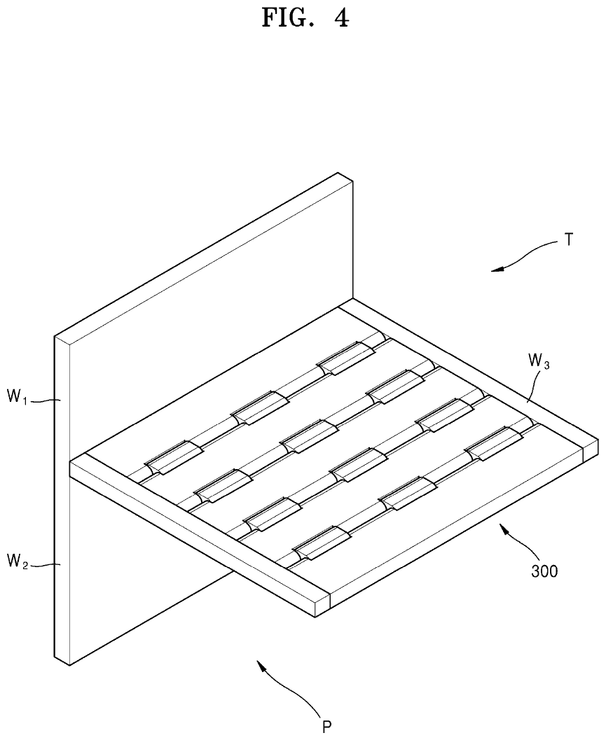

FIG. 4 is a perspective view of a base frame 300 shown in FIGS. 2 and 3.

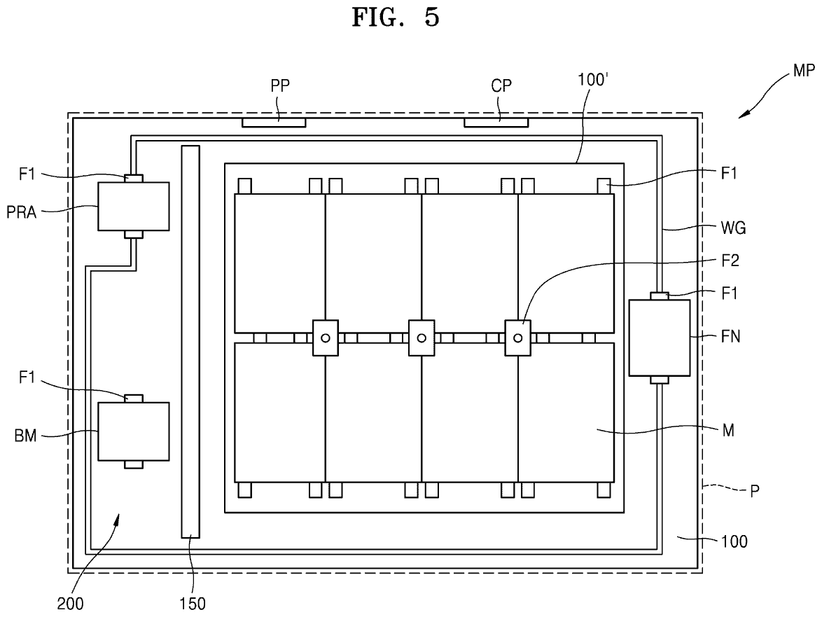

FIG. 5 is a view for describing a configuration of the pack space P shown in FIG. 1.

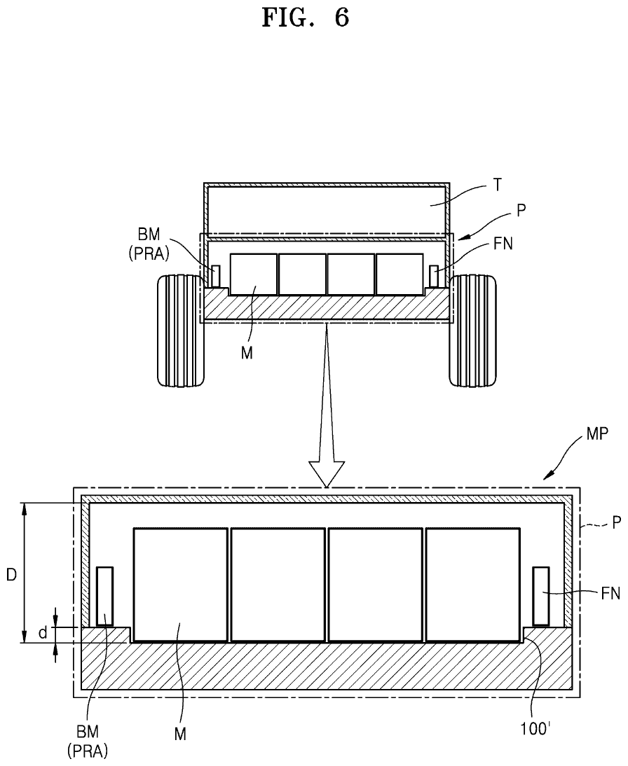

FIG. 6 is a view for describing an arrangement structure of the battery module assembly MP arranged in an electric vehicle.

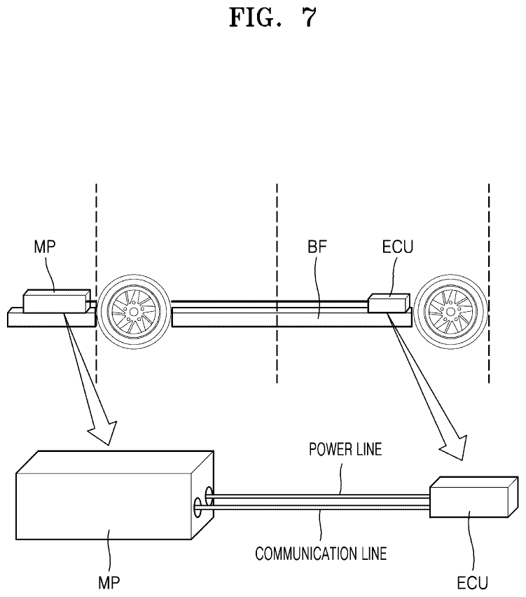

FIG. 7 schematically shows connection of a power line and a communication line between the battery module assembly MP and a vehicle controller ECU.

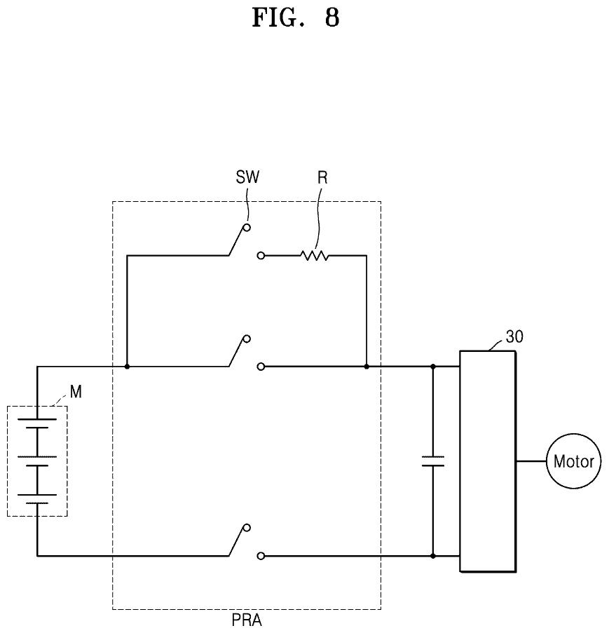

FIG. 8 shows a power relay assembly for opening and closing a power flow between a plurality of battery modules M and a driving motor.

Referring to the drawings, the battery module assembly MP according to embodiments of the present disclosure may include the plurality of battery modules M and a pack space P accommodating the plurality of battery modules M. The pack space P may include a recessed space 100′ having a bottom surface, a part of which is locally recessed to receive at least a part of each of the plurality of battery modules M. The pack space P may also include a module mounting portion 100 on which the plurality of battery modules M accommodated in the recessed space 100′ are disposed, and a circuit mounting portion 200 on which a circuit component electrically connected to the battery module M is disposed. A barrier 150 may be formed between the module mounting portion 100 and the circuit mounting portion 200, and a wire guide WG may connect the module mounting portion 100 to the circuit mounting portion 200 across the barrier 150.

In embodiments of the present disclosure, the battery module assembly MP may include the plurality of battery modules M electrically connected to each other and the pack space P accommodating the plurality of battery modules M. In embodiments of the present disclosure, the pack space P may be formed by a plurality of walls surrounding the pack space P, and the bottom surface of the pack space P may be divided by a wall provided from a vehicle body of an electric vehicle using the plurality of battery modules M as a driving power source. That is, in embodiments of the present disclosure, at least some walls dividing the pack space P may be provided from the vehicle body of the electric vehicle. For example, in embodiments of the present disclosure, the bottom surface of the pack space P may be provided from the vehicle body of the electric vehicle using the plurality of battery modules M accommodated in the pack space P as the driving power source, and a top surface of the pack space P may be provided from a base frame 300 assembled on the vehicle body of the electric vehicle rather than directly from the vehicle body of the electric vehicle using the plurality of battery modules M accommodated in the pack space P as the driving power source. As such, in embodiments of the present disclosure, the pack space P accommodating the plurality of battery modules M may be provided with the bottom surface thereof from the vehicle body of the electric vehicle using the plurality of battery modules M as the driving power source and with the top surface thereof from the base frame 300 assembled on the vehicle body of the electric vehicle using the plurality of battery modules M as the driving power source.

In embodiments of the present disclosure, the pack space P accommodating the plurality of battery modules M may be provided as a lower space of a loading space T on which a transfer load is loaded. The pack space P and the loading space T may be divided by a sliding guide W3 of the base frame 300 that extends between the pack space P and the loading space T and by a foldable cover CV slidably supported on the sliding guide W3. The foldable cover CV may include a cover roller (not shown) moving on the sliding guide W3 so as to be foldably supported on the sliding guide W3 through rotation of the cover roller (not shown). The foldable cover CV may include a plurality of cover segments connected by a hinge to be folded and unfolded with respect to each other. As the plurality of cover segments connected by the hinge may overlap or may be unfolded with respect to each other, they close or open the pack space P through folding and unfolding.

In embodiments of the present disclosure, the loading space T on which the transfer load is loaded and the pack space P accommodating the plurality of battery modules M may be spatially separated from or connected to each other by the foldable cover CV being stretched and compressed along the sliding guide W3 of the base frame 300, with the foldable cover CV closing the pack space P from the loading space T or opening the pack space P toward the loading space T. In embodiments of the present disclosure, the foldable cover CV or the sliding guide W3 (the base frame 300) for guiding sliding of the foldable cover CV may separate the loading space T and the pack space P, which are stacked vertically, from each other. That is, the foldable cover CV and the sliding guide W3 (the base frame 300) for guiding the foldable cover CV may be provided over the top surface of the pack space P. The bottom surface of the pack space P may be provided from the vehicle body of the electric vehicle on which the base frame 300 is assembled.

In embodiments of the present disclosure, the base frame 300 may include the foldable cover CV extending across between the loading space T and the pack space P or the sliding guide W3 for guiding sliding of the foldable cover CV. The base frame 300 may include an upper wall W1 and a lower wall W2 branching and extending from the sliding guide W3 toward the loading space T at an upper position and the pack space P at a lower position. The base frame 300 according to embodiments of the present disclosure may be assembled on the vehicle body of the electric vehicle using the plurality of battery modules M as the driving power source. The upper wall W1 may extend to an upper position of the loading space T from the foldable cover CV that extends over the top surface of the pack space P or the sliding guide W3 for guiding the foldable cover CV. The lower wall W2 extends to a lower position of the pack space P from the foldable cover CV or the sliding guide W3 for guiding the foldable cover CV. In this case, the upper wall W1 and the lower wall W2 may respectively divide at least a part of the loading space T and the pack space P. The upper wall W1 and the lower wall W2 may respectively define fronts of the loading space T and the pack space P. And when the upper wall W1 and the lower wall W2 define the fronts of the loading space T and the pack space P, it may mean the upper wall W1 and the lower wall W2 define the fronts of the loading space T and the pack space P in a moving direction of the electric vehicle. In embodiments of the present disclosure, the front of the pack space P may be covered by the lower wall W2, the top surface of the pack space P may be covered by the foldable cover CV or the sliding guide W3 for guiding the foldable cover CV, and the bottom surface of the pack space P may be provided on the vehicle body of the electric vehicle using the plurality of battery modules M as the driving power source.

In embodiments of the present disclosure, front positions of the loading space T and the pack space P may mean a center position may bea center of an opening/closing operation of the foldable cover CV disposed between the loading space T and the pack space P. The center position of the operation of the foldable cover CV may mean a position at which a plurality of cover segments are folded onto each other while pivoting around a hinge in the opening operation where the foldable cover CV is folded. The foldable cover CV may close a top of the pack space P by being unfolded from the center position. The transfer load may be loaded on the loading space T by using, as a support base, the foldable cover CV covering the top of the pack space P and forming a bottom of the loading space T. In embodiments of the present disclosure, the loading space T and the pack space P may be formed such that the rear of the loading space T and the pack space P is open. Thus, the loading space T and the pack space P may accommodate the transfer load or the battery modules M and peripheral components connected thereto through the open rear.

In embodiments of the present disclosure, the pack space P may include the recessed space 100′ having a bottom, a part of which is locally recessed to accommodate at least a part of each of the plurality of battery modules M. Each of the plurality of battery modules M may be in dense (i.e., compact) arrangement with respect to each other with at least a parts of the battery modules being accommodated in the recessed space 100′ Given the arrangement, a binding mechanism (e.g., an end plate or a side plate) may not be used for binding the plurality of battery modules M to each other. For example, the battery module assembly MP may include the plurality of battery modules M in close arrangement where they are densely arranged with respect to each other without including physical binding with respect to each other. In embodiments of the present disclosure, even when the plurality of battery modules M do not use a separate binding mechanism for binding them to each other (the module M are not physically bound to each other) the plurality of battery modules M forming the battery module assembly MP may still be provided in a dense arrangement with respect to each other, thereby stably maintaining electric connection between the battery modules M that is not susceptible to interruption. Further, the electric connection between different battery modules M may not be subject to stress such as stretching or compression due to position changes of the different battery modules M that are connected to each other. In embodiments of the present disclosure, the dense arrangement of the plurality of battery modules M may include other components capable of providing a binding force to the plurality of battery modules M so as not to leave a limited area or a limited region. And in embodiments of the present disclosure, the plurality of battery modules M may be arranged in a dense form with respect to each other while at least a parts of the battery modules M are accommodated in the recessed space 100′ that is concavely recessed in the bottom surface forming the pack space P.

In embodiments of the present disclosure, the plurality of battery modules M accommodated in the pack space P and a series of components (corresponding to a battery pack) including a circuit component connected to the plurality of battery modules M may be formed in a pack-less structure and may not include a housing demarcating the battery pack and the peripheral components. For example, the battery module assembly MP according to embodiments of the present disclosure may not include a housing for forming the plurality of battery modules M and the circuit components electrically connected to the plurality of battery modules M as one package separated from the electric vehicle using the plurality of battery modules M as a driving power source. In other words, in embodiments of the present disclosure the battery pack may be accommodated in the pack space P but may not include a housing for demarcating the plurality of battery modules M and the circuit components (corresponding to the battery pack) connected to the plurality of battery modules M.

In embodiments of the present disclosure, the pack space P may be formed integrally with the electric vehicle so as not to be separated from the electric vehicle, and the bottom surface of the pack space P may be provided by the vehicle body of the electric vehicle. The pack space P may be formed under the loading space T on which the transfer load is loaded. In embodiments of the present disclosure, the pack space P may be formed as a part of the electric vehicle, and more specifically, the pack space P may be a component of the electric vehicle rather than a component of the battery pack. For example, as shown in FIG. 7, the bottom surface of the pack space P may be provided by a bottom frame BF forming a frame supporting a bottom of the electric vehicle. In other words, the bottom surface of the pack space P may be provided by the bottom frame BF forming a part of the electric vehicle rather than being a component of the battery pack.

In embodiments of the present disclosure, when the battery pack is formed in a pack-less form, it may mean that the battery pack may not include a component for accommodating or binding the plurality of battery modules M and the battery pack may be accommodated inside the pack space P to allow identification of a boundary between the battery pack and a surrounding environment thereof.

Referring to FIG. 5, in embodiments of the present disclosure, the pack space P may include the recessed space 100′ having a bottom surface, a part of which is locally recessed to accommodate at least a part of each of the plurality of battery modules. The pack space P may also include the module mounting portion 100 on which the plurality of battery modules M accommodated in the recessed space 100′ are disposed, and the circuit mounting portion 200 on which the circuit components electrically connected to the battery module M are disposed. In embodiments of the present disclosure, the barrier 150 may be formed to extend between the module mounting portion 100 and the circuit mounting portion 200.

The pack space P may include the module mounting portion 100 on which the plurality of battery modules M are mounted. The circuit mounting portion 200 on which circuit components such as a battery system monitor (BSM) or a battery management system (BMS) (hereinafter, collectively referred to as a battery management system BM) for controlling charging/discharging operations of the plurality of battery modules M, and a power relay assembly (PRA) for opening/closing charging/discharging paths of the plurality of battery modules M between the plurality of battery modules M and the driving motor Motor (or an inverter 30 connected to the driving motor, see FIG. 8) are mounted. Herein, the BSM or the BMS may have substantially the same meaning as each other, and may be collectively referred to as the battery management system BM as a controller for controlling overall operations of the plurality of battery modules M including operations of measuring state variables such as a temperature, a current, and a voltage of the plurality of battery modules M and charging/discharging operations of the plurality of battery modules M.

Referring to FIG. 5, in embodiments of the present disclosure, the barrier 150 for separating the different spaces may be disposed between the module mounting portion 100 and the circuit mounting portion 200. In the module mounting portion 100, the recessed space 100′ may be formed to accommodate at least a part of each battery module M such that the plurality of battery modules M may be densely arranged. The wire guide WG may be formed along an edge of the pack space P. The wire guide WG may guide a wire electrically connecting the module mounting portion 100 to the circuit mounting portion 200. The wire guide WG may extend along the edge of the pack space P across the barrier 150 separating the module mounting portion 100 and the circuit mounting portion 200 from each other to electrically connect components of the module mounting portion 100 and components of the circuit mounting portion 200. For example, in embodiments of the present disclosure the wire guide WG may globally surround the pack space P and cross by ends of the barrier 150. On an outer side of the wire guide WG a power port PP electrically connected to the plurality of battery modules M to provide input/output positions for charging/discharging current of the plurality of battery modules M and a communication port CP connected to communicate with the BM for controlling the operations of the plurality of battery modules M may be formed. The power relay assembly PRA and the battery management system BM, and a cooling fan FN may be formed at one side position and the other side position with respect to the module mounting portion 100.

In embodiments of the present disclosure, the circuit mounting portion 200 may include the battery management system BM for monitoring state variables such as a temperature, a current, and a voltage of the plurality of battery modules M and charging/discharging operations and the power relay assembly PRA for turn-on/turn-off controlling a power flow from the battery modules M between the plurality of battery modules M and the driving motor. In embodiments of the present disclosure, the module mounting portion 100 may further include the cooling fan FN for cooling the plurality of battery modules M. The cooling fan FN of the module mounting portion 100 and the power relay assembly PRA of the circuit mounting portion 200 may be electrically connected to each other through a wire guided along the wire guide WG extending between the module mounting portion 100 and the circuit mounting portion 200 and across the barrier 150 disposed between the module mounting portion 100 and the circuit mounting portion 200. The power relay assembly PRA may include a relay turned on/turned off to control the power flow of the plurality of battery modules M between the plurality of battery modules M and the driving motor (the inverter 30 connected to the driving motor, see FIG. 8). As shown in FIG. 8, the PRA may include a pre-charging switch SW for opening and closing a discharging path connected to a pre-charging resistor R to prevent inrush current at the initial stage of discharging of the plurality of battery modules M.

Referring to FIG. 5, in embodiments of the present disclosure, the wire guide WG may be formed in a groove shape recessed from the bottom surface of the pack space P along the edge of the pack space P so as to enclose the module mounting portion 100 surrounding the recessed space 100′, the circuit mounting portion 200, and the barrier 150 between the module mounting portion 100 and the circuit mounting portion 200, The wire guide WG may have a loop shape having opposite ends disconnected from each other along the edge of the pack space P.

Further referring to FIG. 5, in embodiments of the present disclosure, a plurality of fixtures F1 for fixing the positions of the plurality of battery modules M may be formed in the recessed space 100′ where the plurality of battery modules M are accommodated as dense arrangement. The wire guide WG may be formed in the edge of the module mounting portion 100 surrounding the recessed space 100′, and the fixtures F1 for fixing the position of the cooling fan FN may be formed at positions of the opposite ends of the wire guide WG, corresponding to the mounting position of the cooling fan FN. In the circuit mounting portion 200, the fixtures F1 for fixing the position of the power relay assembly PRA may be formed at the positions opposite to and disconnected from each other in the wire guide WG corresponding to the mounting position of the power relay assembly PRA.

The fixture F1 for fixing the position of the battery management system BM may be formed at a position of the opposite to and disconnected from the wire guide WG corresponding to the mounting position of the battery management system BM. The battery management system may be connected to relatively small diameter wire suitable for low current passage such as control signal passage, unlike the PRA and FAN that may be connected to a relatively large diameter wire suitable for high current passage such as power delivery passage. As such, in embodiments of the present disclosure, the wire guide WG may provide receiving space for relatively large diameter wire suitable for high current passage such as a wire connected to the PRA and FAN, as illustrated in the FIG. 5. For example, the fixture F1 of opposite sides of the battery management system BM might be coupled to the bottom of the pack space P without a wire connected to the battery management system BM guided by the wire guide WG. However, in various modifications, a wire connected to the battery management system BM might be guided by way of the wire guide WG together with wire connected to PRA and FAN. In such modifications, the wire connected to the battery management system BM may be guided by way of the wire guide WG.

Referring to FIG. 5, the battery module assembly MP according to embodiments of the present disclosure may include the plurality of battery modules M and the pack space P for accommodating the plurality of battery modules M. The pack space P may provide the fixtures F1 for firmly fixing the plurality of battery modules M and the each of the circuit components connected to the plurality of battery modules M. The fixtures F1 may include a screw engaging portion installed on the bottom surface of the pack space P. In embodiments of the present disclosure, each component forming the battery pack, such as each battery module M, the cooling fan FN, the power relay assembly PRA, the battery management system BM, etc., may be position-fixed on the pack space P by engagement of an engaging means with the fixtures F1 installed on the bottom surface of the pack space P via a flange piece included in each component. For example, in embodiments of the present disclosure each battery module M may be position-fixed on the bottom surface of the recessed space 100′ by the engaging means inserted into the fixtures F1 installed on the bottom surface of the recessed space 100′ via the flange piece formed in each battery module M, and the plurality of battery modules M adjacent to each other may be firmly position-fixed by being forced against the bottom surface of the recessed space 100′ through the engaging means engaged with the fixtures F1 installed on the bottom surface of the recessed space 100′ via a pressing piece F2 pressing the plurality of adjacent battery modules M together. In various embodiments of the present disclosure, the plurality of battery modules M may be position-fixed on the recessed space 100′ through at least one of the engaging means engaged with the fixtures F1 installed on the bottom surface of the recessed space 100′ via the flange piece of the plurality of battery modules M or the engaging means engaged with the fixtures F1 installed on the bottom surface of the recessed space 100′ via the pressing piece F2 pressing adjacent battery modules M together.

Still referring to FIG. 5, the pack space P may include the module mounting portion 100 having the plurality of battery modules M mounted thereon, and the circuit mounting portion 200 having the circuit components, such as the battery management system BM for controlling charging/discharging operations of the plurality of battery modules M and the power relay assembly PRA for opening and closing the charging/discharging paths of the plurality of battery modules M between the plurality of battery modules M and the driving motor. The barrier 150 may be formed to extend across spaces between the module mounting portion 100 and the circuit mounting portion 200. In the module mounting portion 100, the recessed space 100′ may be formed to accommodate at least a part of each battery module M such that the plurality of battery modules M may be formed in a dense (compact) arrangement. The wire guide WG may be formed along an edge of the pack space P. The wire guide WG may guide a wire electrically connecting the module mounting portion 100 to the circuit mounting portion 200. The wire guide WG may extend along the edge of the pack space P and across the barrier 150 separating the module mounting portion 100 and the circuit mounting portion 200 from each other to electrically connect components of the module mounting portion 100 and components of the circuit mounting portion 200.

In embodiments of the present disclosure, the pack space P and the loading space T may be provided from one base frame 300. For example, the pack space P and the loading space T may be provided together from one base frame 300 including the foldable cover CV interposed between the pack space P and the loading space T, with the upper wall W1 and the lower wall W2 extending upwardly and downwardly from the foldable cover CV to divide parts of the loading space T and the pack space P. The pack space P and the loading space T may be divided from each other or connected to each other by opening/closing of the foldable cover CV.

Referring to FIG. 6, in embodiments of the present disclosure, with respect to a total depth D of the pack space P, a relative depth d of the recessed space 100′ may be provided for binding the plurality of battery modules M in a tight arrangement where they are closely arranged with each other, with the space of the depth d accommodating at least a part of each of the plurality of battery modules M. The depth d may be set to about 20% to about 25% of the total depth D.

Referring to FIG. 7, in embodiments of the present disclosure the battery module assembly MP including the pack space P where the plurality of battery modules M are accommodated may be arranged at the rear of the electric vehicle. Driving power may be supplied from the battery module assembly MP arranged at the rear of the electric vehicle toward the vehicle controller ECU arranged in front of the electric vehicle through a power line and a communication line. An abnormal situation of the plurality of battery modules M may be detected to control charging/discharging operations of the plurality of battery modules M or take protective measures for the plurality of battery modules M.

Although the present disclosure has been described with reference to an example shown in the drawings, it will be understood by those of ordinary skill in the art that various modifications and equivalent other examples may be made from the shown examples.

One or more embodiments include a power supply device having reduced weight and volume and having a light, thin, and compact structure by mounting a plurality of battery modules and a circuit component electrically connected thereto directly on an electric vehicle in a pack-less manner without a separate package in which the plurality of battery modules and the circuit component are separated from the electric vehicle.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure.

What is claimed is:

1. A battery module assembly comprising:
a plurality of battery modules; and
a pack space accommodating the plurality of battery modules,
wherein the pack space comprises:
a recessed space having a bottom surface, a part of which is recessed to accommodate at least a part of each of the plurality of battery modules;
a module mounting portion in which the plurality of battery modules accommodated in the recessed space are arranged;
a circuit mounting portion in which circuit components electrically connected to the plurality of battery modules are arranged;
a barrier formed between the module mounting portion and the circuit mounting portion; and
a wire guide connecting the module mounting portion to the circuit mounting portion.

2. The battery module assembly as claimed in claim 1, further comprising a foldable cover opening and closing the pack space,
wherein the foldable cover covers a top surface of the pack space that is opposite to a bottom surface of the pack space.

3. The battery module assembly as claimed in claim 1, wherein each of the plurality of battery modules is position-fixed in the recessed space by:
engaging means engaged with a fixture installed on the bottom surface of the recessed space via a flange piece formed in each of the plurality of battery modules; or
engaging means engaged with a fixture installed on the bottom surface of the recessed space via a pressing piece pressing a plurality of battery modules adjacent to each other.

4. The battery module assembly as claimed in claim 1, wherein the circuit mounting portion comprises:
a battery management system (BMS) configured to control charging and discharging operations of the plurality of battery modules; and
a power relay assembly (PRA) configured to control a power flow from the plurality of battery modules to a driving motor.

5. The battery module assembly as claimed in claim 4, wherein the module mounting portion further comprises a cooling fan for cooling the plurality of battery modules.

6. The battery module assembly as claimed in claim 5, wherein the cooling fan and the power relay assembly of the circuit mounting portion are electrically connected to each other by a wire guided along a wire guide.

7. The battery module assembly as claimed in claim 4, wherein the wire guide is formed in a groove shape recessed from the bottom surface of the pack space along an edge of the pack space to enclose the module mounting portion surrounding the recessed space, the circuit mounting portion, and the barrier between the module mounting portion and the circuit mounting portion, and
wherein the wire guide is formed in a loop shape having opposite ends disconnected from each other, with mounting positions of the PRA and the cooling fan between ends of the loop shape along an edge of the pack space.

8. The battery module assembly as claimed in claim 7, wherein fixtures for fixing the PRA and the cooling fan are formed at the opposite ends of the wire guide that are disconnected from each other, and
wherein each of the PRA and the cooling fan is fixed to the pack space by an engaging member inserted into the fixtures.

9. The battery module assembly as claimed in claim 4, wherein a power port providing input and output positions of charging and discharging power of the battery module and a communication port connected to the BMS to enable data communication with the BMS are formed on an outer side of the wire guide.

10. The battery module assembly as claimed in claim 1, wherein the pack space is formed as a space under a loading space on which a transfer load is loaded.

11. The battery module assembly as claimed in claim 10, wherein the pack space and the loading space are formed integrally with one base frame.

12. The battery module assembly as claimed in claim 11, wherein a foldable cover is arranged on the base frame and is extendable between the pack space and the loading space.

13. The battery module assembly as claimed in claim 12, wherein the pack space and the loading space are divided from or connected to each other by opening and closing of the foldable cover.

14. The battery module assembly as claimed in claim 11, wherein the base frame comprises:
a sliding guide extending between the pack space and the loading space to support sliding of the foldable cover; and
an upper wall and a lower wall each branched upwardly and downwardly from the sliding guide and dividing a part of the loading space and a part of the pack space, respectively.

15. The battery module assembly as claimed in claim 11, wherein the base frame is assembled on a vehicle body of the electric vehicle with the plurality of battery modules being configured to provide a driving power source for the electric vehicle.

16. The battery module assembly as claimed in claim 1, wherein at least a part of wall dividing the pack space is provided by a vehicle body of an electric vehicle.

17. The battery module assembly as claimed in claim 16, wherein the bottom surface of the pack space is provided by the vehicle body of the electric vehicle.

18. The battery module assembly as claimed in claim 1, wherein the plurality of battery modules are provided in a compact arrangement with respect to each other and are at least partially accommodated in the recessed space, and
wherein a binding mechanism for physically binding the plurality of battery modules to each other is not included.

19. The battery module assembly as claimed in claim 1, wherein the battery module assembly is provided with an electric vehicle, with the plurality of battery module being configured to provide a driving power source for the electric vehicle, and
wherein a housing for accommodating the plurality of battery modules and the circuit components electrically connected to the plurality of battery modules in one package separated from the electric vehicle is not included.
